(19) United States
(12) Patent Application Publication
(10) Pub. No.: US 2026/0058902 A1
(43) Pub. Date: Feb. 26, 2026

(54) COORDINATING LINK AGGREGATION CONTROL PROTOCOL (LACP) FALLBACK FUNCTIONALITY USING A DESIGNATED FORWARDER ELECTION MECHANISM

(71) Applicant: Arista Networks, Inc., Santa Clara, CA (US)

(72) Inventors: Victor Shih-Hua Wen, San Jose, CA (US); Alton Lo, Fremont, CA (US); Muhammad Naveed Mozaffar, Frisco, TX (US)

(21) Appl. No.: 18/811,603

(22) Filed: Aug. 21, 2024

(51) Int. Cl. H04L 45/24; H04L 45/02

(52) U.S. Cl. CPC H04L 45/245; H04L 45/04

(57) ABSTRACT

Systems and methods for allowing network devices in an Ethernet Segment(ES) Link Aggregation Group (LAG) to independently perform a deterministic designated forwarder determination. Only one of the devices in the LAG will determine that it is the designated forwarder for the LAG, while the remaining devices will determine that they are not the designated forwarder for the LAG. The device that determines it is the designated forwarder may enable (or maintain) a link to a particular network device while all other devices in the LAG that make the determination they are not the designated forwarder may disable a link to that particular network device.

### BACKGROUND

Efficiently extending connectivity across multiple sites is highly desirable in networking scenarios. Ethernet Virtual Private Network (EVPN) has emerged as an advanced and flexible solution for achieving scalable and secure communication across distributed network environments.

One of the key considerations in the deployment of EVPN is the concept of multihoming. Multihoming refers to the ability of a network device to connect to multiple other network devices simultaneously, enhancing both resiliency and bandwidth availability. Multihoming may utilize Ethernet Segments(ES), and ES Link Aggregation Groups (LAG) to allow multiple physical links between network devices to be used as a single logical link.

Certain protocols functionality, or features utilized to implement, or in association with, these multihomed networked devices may cause issues with the delivery of traffic on the network in certain scenarios. In particular, the routing of traffic across certain links in certain cases, such as before certain types of configuration are fully complete, may cause traffic to be dropped or otherwise blackholed. It is therefore desirable to account for such circumstances in the implementation of multihomed network environments to address such issues.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a block diagram of a network topology including a network device implementing an embodiment.

FIG. 2 is a flow diagram of one embodiment of a flow diagram illustrating one embodiment of a method for determining a designated forwarder.

FIG. 3 is a flow diagram of one embodiment of a flow diagram illustrating one embodiment of a method for determining a designated forwarder.

FIG. 4 is an example of a network topology including a network device implementing an embodiment.

### DETAILED DESCRIPTION

Ethernet Virtual Private Network (EVPN) is a widely utilized solution for achieving scalable communication across distributed network environments. EVPN is a network overlay solution designed to provide scalable and efficient interconnectivity between geographically dispersed sites or data centers over an existing IP (Internet Protocol) infrastructure. EVPN leverages the capabilities of the Border Gateway Protocol (BGP) to enable the distribution of MAC (Media Access Control) and IP routing information across the network, facilitating the creation of overlay networks with improved scalability, flexibility, and ease of deployment.

One of the key considerations in the deployment of EVPN is the concept of multihoming. Multihoming refers to the ability of a network device to connect to multiple other network devices simultaneously, enhancing both resiliency and bandwidth availability. EVPN supports multi-homing through mechanisms such as Ethernet Segments(ES) and Ethernet Segment Identifiers (ESI), allowing for the creation of redundant and load-balanced connections between network devices. Internet Engineering Task Force (IETF) RFCs 7432, 8365 and 9014 (incorporated herein by reference in their entirety) describe EVPN and multihoming in such EVPN networks.

Specifically, links can be assigned into the same ESI, introducing an important link aggregation feature that introduces redundancy to devices in an EVPN network. The bundled links that are numbered with an ESI are often referred to as a Link Aggregation Group (LAG) or ES LAG. Establishing a LAG allows multiple physical links between network devices to be used as a single logical link. Accordingly, multihoming in EVPN networks is heavily dependent on these LAGs. Thus, some network switches are configured with functionality that allows them to automatically set up LAGs. Link Aggregation Control Protocol (LACP) is often utilized or supported in such multi-homed EVPN to allow such LAGs to be managed (e.g., set up, configured, altered, etc.).

In a particular application of LACP, for example, LACP fallback functionality in a network device can allow an active LACP interface to establish a port-channel LAG before the device receives LACP Protocol Data Units (PDUs) from its peers. This feature is useful in environments where users may have Preboot Execution Environment (PXE) Servers or a device connected with an LACP port channel.

There are, however, scenarios in which problems arise when LACP fallback is used to establish a LAG. Consider, for example, the case in which an Layer 2 (L2) network device (e.g., switch in this example) is being connected to a network. More specifically, an L2 switch can be connected via EVPN ES links to a pair of leaf switches for redundancy. This configuration may thus be an active multi-homing configuration in which the L2 switch is multi-homed to the leaf switches.

In this scenario the L2 switch may initially have no configuration information and need to be provisioned, so the switch may attempt to contact a server Using Dynamic Host Configuration Protocol (DHCP) to get an IP address assigned to the switch (e.g., so the switch can download needed configuration information to continue the PXE boot process). When the IP address is returned from the DHCP server, it may hash to a first one of the leaf switches and is forwarded from this leaf to the L2 switch. The interface of the L2 switch that is connected to the first leaf switch is thus configured with the received IP address.

After the IP address is received, the L2 switch needs to obtain configuration information (e.g., from the DHCP/HTTP server), so the switch may send out an Address Resolution Protocol (ARP) request. The ARP request hashes to either the first leaf switch or the second leaf switch and is forwarded from that leaf switch to the DHCP server, which generates an ARP reply. The ARP reply may therefore hash to either the first leaf switch or the second leaf switch. Because there is not yet any coordination between the leaf switches, the LACP fallback mechanism cannot ensure that only a single one of the links (e.g., LAGs) from the leaf switches to the L2 switch is active.

If the ARP reply hashes to the first leaf switch, the reply is forwarded to the L2 switch and the L2 switch installs the received configuration (e.g., can proceed with the PXE boot process because ARP information is available). If, however, the ARP reply hashes to the second leaf switch, the interface of the L2 switch which is connected to the second leaf switch does not have an IP address, so the ARP reply will usually be dropped.

Embodiments as disclosed herein may address these types of problems, among others, by leveraging a designated forwarder election mechanism. The designated forwarder mechanism causes each of the (e.g., leaf) switches or other devices in an ES LAG to perform a deterministic procedure in order to determine whether that device is a designated forwarder for that LAG. Only one of the devices (e.g., switches) in the LAG will determine that it is the designated forwarder for the LAG, while the remaining devices (e.g., leaf or other types of switches) will determine that they are not the designated forwarder for the LAG.

Such a designated forwarder determination may be performed after the network devices (e.g., leaf switches) determine that the port channels connecting them to the other network device (e.g., an L2 switch) are up. p Because the port channel of each leaf switch is configured as part of the same ES LAG, each device (e.g., leaf switch) will advertise a Type 4 (e.g., ES) route to the other devices (e.g., leaf switches) in the LAG. When the Type 4 routes have been exchanged between the devices (e.g., leaf switches), each network device (e.g., leaf switch) will perform the designated forwarder election procedure.

In some embodiments, the designated forwarder election procedure uses the router identifiers (IDs) of the network device (e.g., leaf switches) to determine the designated forwarder. Each network device (e.g., leaf switch) compares the router IDs for all of the network devices (e.g., leaf switches) in the ES LAG and the network device (e.g., leaf switch) with the smallest router ID is determined to be the designated forwarder. Other criteria (e.g., largest) may be used to evaluate the router ID to determine the network device to be used as the designated forwarder and other deterministic algorithms may be used in other embodiments.

In this manner, the designated forwarder election procedure is deterministic, in that the result determined by each network device (e.g., leaf switch) will be the same. Once the designated forwarder election procedure has been performed by each of the network devices (e.g., leaf switches), the network device (e.g., leaf switch) which is the designated forwarder (in this example, the one with the smallest router ID) will keep its fallback ES LAG link up, while the other network devices (e.g., leaf switches) will remove their respective physical ports from the LAG, effectively bringing down the link for each of these network devices (e.g., leaf switches).

After the L2 switch loads the configuration, it will send LACP packets to all of the network devices (e.g., leaf switches) in the ES LAG, including the network device (e.g., switch) which is the designated forwarder and the network devices (e.g., switches) which are not the designated forwarder. Upon receipt of the LACP packets, the network devices (e.g., leaf switches) in the ES LAGs will exit LACP fallback mode, and normal LACP negotiations will take place. Once the ES LAG is no longer in LACP fallback mode, the designated forwarder role will no longer affect the link status of ES LAG and, if LACP negotiation is successful, the LAG manager will add the physical links to both the designated forwarded and the non-designated forwarder ES LAGs on the leaf switches and the ES LAGs will link up.

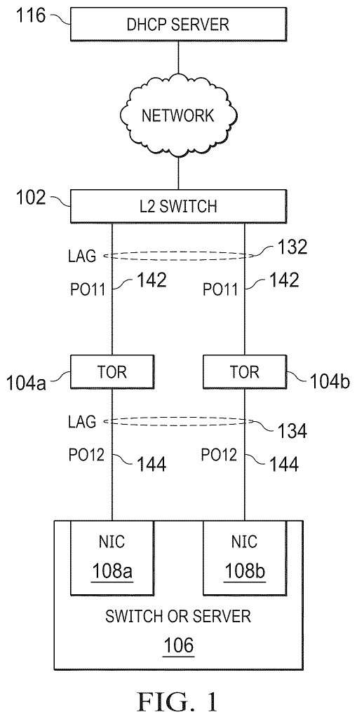

Looking then at FIG. 1, an example network topology in which the disclosed embodiments may be implemented. It should be understood that while embodiments will be described herein with respect to a topology including leaf devices (switches) in a leaf-spine topology, other embodiments may also be effectively applied in association with other network topologies and all such embodiments are fully contemplated herein without loss of generality.

In the depicted example, a Layer 2 (L2) switch 102 is connected to a pair of leaf devices 104 and a DHCP server 110. The leaf devices may, for example, be Top-of-Rack switches (TORs), identified in the figure as TOR leaf A 104a and TOR leaf B 104b. The TOR leaf switches are Ethernet Virtual Private Network (EVPN) devices, and there is a Layer 3 (L3) connection between the TOR leaf switches 104. It should be noted that different instances of the same or similar devices may be identified herein by a common reference number followed by a letter. For instance, as depicted in FIG. 1, TOR leaf switches are referred to using reference numerals 104a-104b . The individual devices may be referred to by the number and letter (e.g. 104a), or they may be referred to generically or collectively by the number alone (e.g., TOR leaf switches 104).

TOR leaf switches 104 are also connected to a second device 106, which may be a switch or another type of device, such as a server or the like. In this example, switch (or server, etc.) 106 has a pair of Network Interface Cards (NICs) 108, each of which is connected to a corresponding one of the TOR leaf switches. Switch 106 is dual home connected to TOR leaf switches 104 for active multi-homing. TOR leaf switch A is connected to physical Ethernet interface et1 on NIC 108a, while TOR leaf switch B is connected to physical Ethernet interface et2 on NIC 108b.

The multihoming feature enables switch 106 to be connected to two or more devices (in this example, TOR leaf switches 104) to provide redundant connectivity. In the example of FIG. 1, switch 106 is multihomed through TOR leaf switches 104 to switch 102, but it could be multihomed to multiple devices. EVPN multihoming helps to maintain EVPN service and traffic forwarding to and from the multihomed device (switch 106) in the event of network failures.

The ES links 142 between L2 Switch 102 and TOR leaf switches 104 form a first LAG 132, so that when traffic at switch 102 (e.g., a reply from DHCP server 110) is destined for switch 106, the traffic is hashed to one of the links 142 (i.e., directed to one or the other of the links based on a hash function).

Thus, a reply received at switch 102 will be directed to switch 106 either through TOR leaf switch A 104a, or through TOR leaf switch B 104b.

Similarly, the ES links 144 between switch 106 and TOR leaf switches 104 form a second LAG 134, so that when traffic at switch 106 (e.g., an ARP request) is destined to the DHCP server via L2 switch 102, the traffic is hashed to one of the links 144 and is directed to switch 102 either through TOR leaf switch A 104a, or through TOR leaf switch B 104b.

It should be noted that the physical ES links that form a LAG are considered to be a single logical link. For example, the first LAG 132 (which includes two physical links 142) is treated as a single logical link or port channel. Likewise, the two physical links 144 of the second LAG 134 will be treated as a single logical link or port channel, even in cases where switch 106 is not yet configured and therefore cannot do so yet. When the switch 106 is initially provisioned, there is no configuration on the device. The switch 106 may therefore attempt to perform a zero-touch provisioning (ZTP) boot, where the device tries to contact a DHCP server 116 to get an IP address, sends an ARP request to the DHCP server 116, and then tries to download the necessary configuration (e.g., from an HTTP server).

Since the example topology illustrated in FIG. 1 is a multihoming arrangement, the links 144 to both TOR leaf switch A 104a and TOR leaf switch B 104b are active. In other words, switch 106 is connected to both TOR leaf A 104a and TOR leaf B 104b. Since both links 144 are up and active, when the switch 106 boots up (or otherwise re-initializes) and sends out a DHCP request to get an IP address, that request would be sent to both TOR leaf A 104a (e.g., via ethernet interface et1 on NIC108a) and TOR leaf B 104b (e.g., via ethernet interface et2 on NIC108b). The requests from the two TOR leaf switches 104 are sent out to L2 switch 102, which then forwards the requests to DHCP server 110.

When DHCP server 116 receives the DHCP requests, both requests have the same MAC address of the switch 106, so the DHCP server 116 may send only one response back to switch 106. When or if DHCP server 116 sends the response to the DHCP request, the response (which has the requested IP address) will be returned through L2 Switch 102 and one of TOR leaf switches 104 to switch 106. In some cases, DHCP server 116 might send back a response for every request. However, these responses will take the same path back to switch 106 on either NIC 108a or NIC 108b. In such cases only a response matching the request sent by the receiving NIC will be accepted.

Assuming the DHCP response is returned to switch 106 via TOR leaf switch A 104a, the corresponding interface (et1 ) on NIC 108a will be configured with the IP address that was provided by the DHCP server 116. It will be noted at this point that if the DHCP response instead hashes to TOR leaf switch B 104b, the interface for that switch (et2 ) on NIC 108b will be configured with the IP address that was provided by the DHCP server 116, and references to the interfaces in the description below would be reversed. After the interface to TOR leaf switch A 104a is configured with the IP address, switch 106 needs to get the actual configuration for the switch.

Before it can obtain such a configuration, switch 106 sends out an ARP request to obtain ARP information for DHCP server 116. The ARP request can be sent on either TOR leaf switch A 104a or TOR leaf switch B 104b. In the case that the ARP request hashes to TOR leaf switch A 104a, the ARP request is sent through TOR leaf switch A 104a to L2 switch 102, and is then forwarded to DHCP server 116.

At this point, no problems may have occurred. Problems may arise when the DHCP server 116 replies to an ARP request in this scenario. Because the links 142 from L2 switch 102 to TOR leaf switch A 104a and TOR leaf switch B 104b form a LAG 132, the reply may hash to either one of the TOR leaf switches 104. In the event that the reply hashes to TOR leaf switch A 104a, the reply will be forwarded to switch 106 via interface et1 on NIC 108a, which has the IP address assigned to it, so that switch 106 can get resolution for the MAC and IP addresses. Then switch 106 can contact an HTTP server that stores the needed configuration in order to obtain that configuration. After the configuration has been obtained, switch 106 can reboot (or otherwise reinitialize) and begin operating with this obtained configuration.

If, on the other hand, the reply to the ARP request which is received by switch 102 hashes to TOR leaf switch B 104b, the reply will be forwarded to switch 106 via interface et2 on NIC 108b, which does not have an IP address assigned to it. In certain cases, by default all the interfaces on the switch 106 may be L3 when the switch is in ZTP mode and, for security purposes, if an interface doesn't have an IP assigned, any packet that is destined for the switch 106 on that interface may be dropped. Thus, in the scenario in which the ARP reply hashes to TOR leaf switch B 104b, switch 106 will drop the reply because it is received on NIC 108b, which does not have an assigned IP address. As a result of this failure of the ARP resolution, switch 106 is not able to get the ARP information for DHCP server 116 and cannot contact a server to get the necessary configuration.

One way to address this problem involves the use of the LACP fallback mechanism. TOR leaf switch A 104a and TOR leaf switch B 104b are already configured, so these TOR leaf switches 104 can be controlled so that the link for only one of them comes up, while the link for the other does not. If a packet is received by the TOR leaf switch 104 for which the corresponding link is up, the packet is forwarded to the destination device normally. If, on the other hand, the packet is received by the TOR leaf switch 104 for which the corresponding link is down, the TOR leaf switch 104 passes the packet to the other TOR leaf switch 104 for which the corresponding link is up, and the second TOR leaf switch 104 forwards the packet to the destination device.

Generally, it is desirable to have the TOR leaf switches configured the same way. In order for LACP fallback to work as described in the above scenario, however, it is necessary to configure the TOR leaf switches differently. Because the operator (e.g., owner or administrator) of the TOR switches has to configure them differently, there is an additional burden placed on the switch operator and this burden increases with the number of switches and LAGs that are involved. This arrangement is thus typically very hard to manage. Additionally, there may be configuration consistency checks that are made by the operator of the TOR leaf switches, and differences in the configurations of the switches can cause confusion as to whether the switches are properly configured.

It should also be noted that, while there are scenarios in which LACP fallback works properly in identically configured switches of a LAG, the switches must be able to communicate with each other in order to be able to negotiate which of the switches will keep its link up and which will keep their links down. In certain cases, LAGs formed by EVPN ESs may not have the necessary communication between switches, such that the LACP fallback mechanism may not be effectively utilized for those types of ES LAGs. In other words, the switches may operate independently from each other and there is no synchronization between them, so neither of the switches is aware of the configuration of the other switch.

Disclosed embodiments may therefore use a Designated Forwarder (DF) election mechanism to enable each of the switches that are involved in a LAG to determine, without requiring negotiation communications, which of the involved switches will be responsible for forwarding packets until a new device (e.g., switch or server) is configured and the LAG is established for that new device (e.g., switch or server).

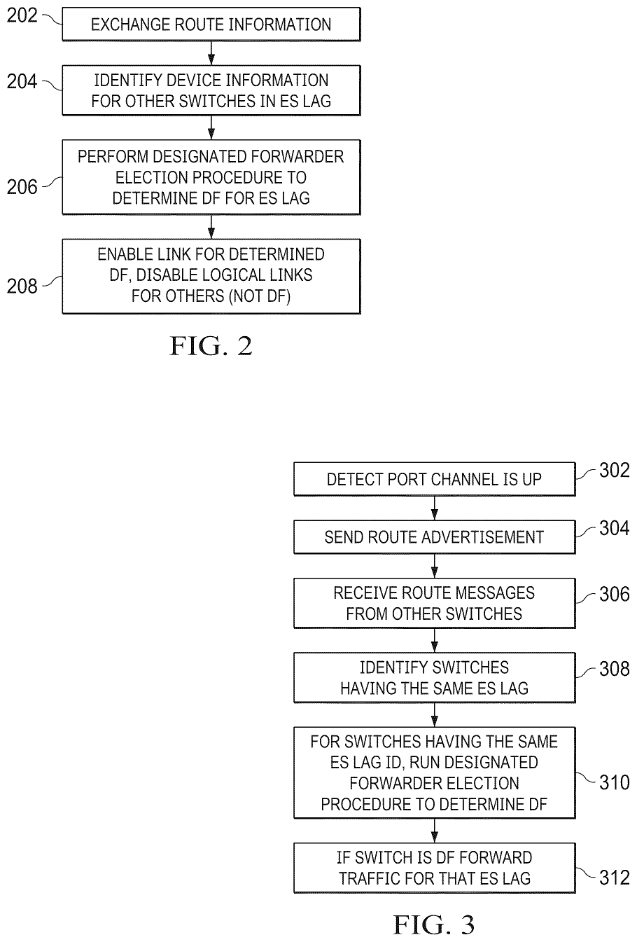

Moving to FIG. 2, a flow diagram illustrating one embodiment of a method for determining a DF for an ES LAG that may be employed by switches (or other devices) in that ES LAG is shown. At STEP 202, the switches in the ES LAG exchange route information. Each switch publishes its own (e.g., LAG) information and receives information published by the other switches. The exchanged information enables each switch to determine which of the other switches are in the same ES LAG.

At STEP 204, each switch extracts device specific information for each of the other switches that is determined to be part of the same ES LAG. At STEP 206, each switch then independently performs a designated forwarder election procedure to determine which of the switches (e.g., in the same LAG) is the DF for the ES LAG. This designated forwarder election procedure may include performing a common deterministic algorithm using the extracted information for the switches in the ES LAG in order to determine which of the switches is the DF for the ES LAG. At STEP 208, each switch independently either enables (or maintains) the logical link for the ES LAG or disables the logical link for the ES LAG based on the results of the designated forwarder election procedure on that switch. Specifically, if the result of performing the designated forwarder election procedure on the switch determines that the switch is to be the DF for the ES LAG the logical link may be enabled (or maintained), while, if the result of performing the designated forwarder election procedure on the switch determines that the switch is not the DF for the ES LAG, the logical link for the ES LAG for that switch may be disabled.

Thus, after the method of FIG. 2 has been performed (e.g., by the switches in an ES LAG), because of the deterministic nature of the designated forwarder election procedure only one of the switches in the ES LAG will have determined itself to be the DF, and the other switches will have determined that they are not the DF. Accordingly, only one of the switches - the one that determined itself to be the DF (the DF switch) - will have maintained a logical link for the ES LAG, while the links for the other switches will be down. Thus, packets received by the DF switch will be forwarded to their destination via the corresponding enabled logical link, and packets received by other switches in the ES LAG will not be forwarded.

Referring now to FIG. 3, a flow diagram illustrating another embodiment of a method for determining a DF for an ES LAG is shown. Embodiments of this method may be performed by each of the switches that may form part of an ES LAG. All of the switches may be identically configured with respect to performing such a method and thus may independently perform the same method, including performing the same deterministic designated forwarder election procedure to identify a DF for an ES LAG.

At STEP 302, the method may be triggered at a switch when it is detected that a port channel connecting the switch to a new network device is up. As an example, as depicted in FIG. 1, when switch 106 is connected to TOR leaf switch A (104a) and TOR leaf switch B (104b), each of these switches 104 may detect that port channel 12 (“po12”) is up.

At STEP 304, in response to detecting that the port channel is up, each switch sends out a message with its route information. At STEP 306, each of the switches receives the messages from the other switches with their respective route information. Such messages may be, for example, Type 4 ES route messages.

At STEP 308, each of the switches examines the route information received from the other switches and uses this information to identify ones of the switches that are associated with the same ES LAG. For example, again referring again to FIG. 1, TOR leaf switch A (104a) forms part of ES LAG 134, so it examines the information received from TOR leaf switch B (104b) to determine whether TOR leaf switch B (104b) also forms part of ES LAG 134. In certain cases, a EVPN Type 4 route message for each switch includes an identifier of the ES LAG to which the switch that sent the message belongs, so each switch will compare its own ES LAG identifier with the ES LAG identifier in the received Type 4 message. If the identifiers match, the (sending) switch corresponding to the received message is in the same ES LAG as the (receiving) switch making the determination.

At STEP 310, the switch uses information stored at the switch and the information from other switches that have been determined to be a part of the same ES LAG to determine the DF for the ES LAG using a designated forwarder determination procedure. In particular, information obtained through the Type 4 route message may include device identifiers (router IDs) for the corresponding switches. These device identifiers may be used by the switch to perform the designated forwarder determination procedure by applying a deterministic algorithm based on the device identifiers to identify the DF for the ES LAG.

It will be noted here that the deterministic algorithm applied by the designated forwarder determination procedure may vary from one embodiment to another, but the same deterministic algorithm will be used by every switch for the designated forwarder determination procedure in a given embodiment. Because the deterministic algorithm is the same for each switch, and because each switch uses the same information (e.g., router IDs or ES identifier) to perform the deterministic algorithm, each switch will produce the same result when that switch performs the deterministic algorithm. In other words, each switch will identify the same specific switch as the DF using the same deterministic algorithm.

In some embodiments, the deterministic algorithm may comprise determining which of the switches in the (e.g., same) ES LAG has the lowest router ID. Whichever switch has the lowest router ID is determined to be the DF. Since each switch is using the same information (the router ID published by each switch in its Type 4 ES route message), each switch identifies the same switch as the DF for the ES LAG, even though there is no negotiation between the switches. In an alternative embodiment, the deterministic algorithm may be based on a determined identifier for each switch to determine which switch identifier (hence which switch) is indicative of the DF for the ES LAG. Again, as long as the algorithm is deterministic each of the switches will independently come to the same determination without any negotiation between the switches.

At STEP 312 then, after the switches have determined the DF, the determined DF (switch) will take responsibility for forwarding packets until the device (e.g., switch or server) to which the switches of the ES LAG are homed is configured and can hash packets to the switches of the ES LAG. Specifically, in EVPN all-active multihoming, only DF will forward broadcast, unknown unicast, and multicast (BUM) packets in which include ARP request and responses. Thus, only the DF (switch) will keep its ES LAG linkup while the other (non DF) switches remove their physical port member from their ES LAG, effectively bringing their ES LAG link down. As a result, there may be only a single path between server or switch and the EVPN leaf (e.g., because of a single DF guarantee provided by EVPN).

After the PXE server/ZTP switch reloads with LACP configuration, the device will send LACP packets to both DF and NDF leaf. ES LAGs will exit LACP fallback mode upon reception of LACP packets and normal LACP negotiations will take place. Once ES LAG is no longer in LACP fallback mode, EVPN DF/NDF role will no longer affect the link status of ES LAG. If LACP negotiation is successful, the LAG manager will add the physical link(s) to the ES LAG and the LAG will linkup.

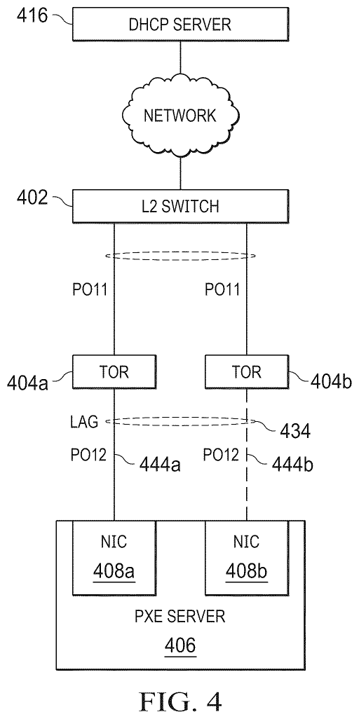

It may now be useful to describe an example of a scenario where embodiments may be particularly useful. In particular, as discussed, embodiments may be useful in environments where users have servers or switches undergoing a PXE boot process that are connected with a LACP port channel. FIG. 4 depicts one example of a PXE server 406 connected to TOR switch 404a and TOR switch 404b for redundancy. With one type of LACP fallback feature, LAG 434 may be brought up (before receiving any LACP PDUs from a server) and a single port kept active for LAG 434 after a fallback expiry timeout period. This allows PXE server 406 to establish a connection over its NIC(s) 408, get an IP address, download its boot image and then continue the booting process. When the server boot process is complete, the server 406 will fully form a LACP LAG.

Here, using embodiments as disclosed, TOR switches 404 may determine a DF for ES LAG 434. In this manner there will only be a single path from PXE server 406 to DHCP server 416 before a LACP LAG is fully formed. For example, if TOR switch 404a is determined to be the DF for ES LAG 434, only TOR switch 404a's ES LAG link 444a may be up (with respect to ES LAG 434). Here, only NIC 408a at PXE server 406 will be able to communicate with DHCP server 416 successfully for an IP address and continue with the PXE process. In this manner, if an ARP reply (or any other data) is hashed to TOR 404b by L2 switch 402 (e.g., before the LACP LAG is fully formed), since TOR 404b's local ES LAG link 444b is down, the ARP reply packet will be tunneled to TOR 404a and reach PXE server 406 through link 444a and NIC 408a. Similarly, any other traffic (e.g., a boot image) hashing to TOR switch 404b will reach TOR switch 404a and subsequently the PXE server 406 via the same mechanism.

It will be understood that while specific embodiments have been presented herein, these embodiments are merely illustrative, and not restrictive. Rather, the description is intended to describe illustrative embodiments, features and functions in order to provide an understanding of the embodiments without limiting the disclosure to any particularly described embodiment, feature, or function, including any such embodiment, feature, or function described. While specific embodiments of, and examples for, the embodiments are described herein for illustrative purposes only, various equivalent modifications are possible within the spirit and scope of the invention, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments of the invention will be employed without a corresponding use of other features, and features described with respect to one embodiment may be combined with features of other embodiments without departing from the scope and spirit of the disclosure as set forth.

What is claimed is:

1. A system comprising:
a plurality of network switches, each network switch having a corresponding physical link adapted to be connected to a first network device, the physical links adapted to form an Ethernet Segment(ES) Link Aggregation Group (LAG), wherein each of the network switches is adapted to:
exchange route information with others of the plurality of network switches;
perform a deterministic designated forwarder determination procedure to determine whether the network switch is a designated forwarder of the ES LAG;
if the network switch is determined to be the designated forwarder, enabling a logical link between the network switch and the first network device; and
if the network switch is determined not to be the designated forwarder, disabling any logical link between the network switch and the first network device.

2. The system of claim 1, wherein each of the plurality of network switches comprises a leaf switch.

3. The system of claim 2, wherein each of the plurality of network switches comprises a Top-of-Rack switch (TOR).

4. The system of claim 1, wherein each network switch is adapted to exchange the route information by advertising the route information for the network switch in a Type 4 ES route message.

5. The system of claim 4, wherein each network switch is adapted to advertise the route information for the network switch in the Type 4 ES route message in response to determining that a port channel connecting the network switch to the first network device is up.

6. The system of claim 1, wherein each network switch is identically configured.

7. The system of claim 1, wherein each network switch performs the deterministic designated forwarder determination procedure based on identifiers corresponding to each of the network switches.

8. The system of claim 7, wherein the identifiers corresponding to each of the network switches comprise router IDs.

9. The system of claim 1, wherein the deterministic designated forwarder determination procedure comprises determining which of the network switches has a lowest router ID, wherein the network switch having the lowest router ID is determined to be the designated forwarder.

10. A method, comprising:
receiving route information from one or more additional network switches at a first network switch in an Ethernet Segment(ES) Link Aggregation Group (LAG);
identifying one or more of additional network switches, wherein the first network switch and the identified one or more of additional network switches comprise the ES LAG;
performing a deterministic designated forwarder determination procedure to determine a designated forwarder of the ES LAG;
if the first network switch is determined to be the designated forwarder, enabling a link between the network switch and a network device; and
if the first network switch is determined not to be the designated forwarder, disabling any link between the first network switch and the network device.

11. The method of claim 10, further comprising: publishing, by the first network switch, route information for the first network switch.

12. The method of claim 11, wherein the route information is a EVPN Type 4 route advertisement.

13. The method of claim 11, wherein the first network switch publishes the route information for the first network switch in response to detecting that a port channel connected to the network device is up.

14. The method of claim 10, further comprising identifying the one or more additional network switches by identifying the one or more additional network switches as having a same ES LAG ID as the first network switch.

15. The method of claim 10, wherein the deterministic designated forwarder determination procedure is based on a router identifier associated with each of the first network switch and the one or more additional network switches.

16. The method of claim 15, wherein the deterministic designated forwarder determination procedure comprises a determining the designated forwarder based on the lowest router identifier associated with the first network switch or the one or more additional network switches.

17. The method of claim 10, wherein the network device is a switch or a server.

18. The method of claim 17, wherein the server is going through a Preboot Execution Environment (PXE) process.

19. The method of claim 10, wherein the first network switch and the one or more additional network switches are TOR switches of leaves in a network.

20. A non-transitory computer readable medium, comprising instructions for:
publishing a Type 4 route advertisement for a first network device in an Ethernet Segment(ES) Link Aggregation Group (LAG) in response to detecting that a port channel connected to a network device is up;
receiving Type 4 route advertisements from one or more additional network switches in the ES LAG at the first network switch;
performing a deterministic designated forwarder determination procedure to determine a designated forwarder of the ES LAG based on a router identifier associated with the first network switch and the one or more additional network switches;
if the first network switch is determined to be the designated forwarder, enabling a link between the network switch and a network device; and
if the first network switch is determined not to be the designated forwarder, disabling any link between the first network switch and the network device.
